(19) United States
(12) Patent Application Publication
(10) Pub. No.: US 2012/0097879 A1
(43) Pub. Date: Apr. 26, 2012

(54) COMPRESSED GAS CYLINDER WITH AN INTEGRAL VALVE

(75) Inventor: Scott Jay GILBERT, Menlo Park, CA (US)

(73) Assignee: Capnia, Inc., Palo Alto, CA (US)

(21) Appl. No.: 13/091,057

(22) Filed: Apr. 20, 2011

Related U.S. Application Data
(60) Provisional application No. 61/326,183, filed on Apr. 20, 2010.

(51) Int. Cl. F16K 5/00; F17C 1/00

(52) U.S. Cl. 251/309; 220/581

(57) ABSTRACT

Described here are devices including gas cylinders for use in various applications. The applications may comprise the dispensing and administration of a compressed gas to the nasal mucosa of a user. The devices generally include an integral valve comprised of a valve seat and a valve pin. The orifice of the valve seat may be configured to limit the flow rate of the gas.

### CROSS-REFERENCE TO RELATED APPLICATIONS

This application claims priority to U.S. Provisional Application Ser. No. 61/326,183 filed on Apr. 20, 2010, which is hereby incorporated by reference in its entirety.

### FIELD

Described here are small gas cylinders having integral valves. More specifically, valves that are integrated into at least a portion of the neck of the gas cylinders are described. Methods for using the gas cylinders in the dispensing and administration of a compressed gas, e.g., a therapeutic gas, to the nasal mucosa of a user are also described.

### BACKGROUND

Small compressed gas cylinders are typically constructed with a thin metal cap welded onto the open end of the formed cylinder. The welded cap very effectively seals the gas within the cylinder and, at the same time, is readily pierced with a solid or hollow pin as a means to release the gas. This approach is widely used for small gas cylinders such as carbon dioxide-filled cylinders used for carbonating water or other beverages. Commonly, however, the force required to pierce the welded cap may be about 200N (45 lbf (pound-force)) or more. Since the user must generally affix the cylinder to a dispensing device manually, some mechanical advantage may be required to exert enough force for the cylinder to be pierced. This is typically achieved by using a thread on the cylinder neck or a cam drive lever to force the cylinder into the pin. This process may be cumbersome for the user. Further, if a seal is not formed before the pin pierces the welded cap, then compressed gas will be released until the seal is properly achieved. This is a common complaint about simple pierce pin arrangements. Still further, once pierced, the cylinder cannot be resealed. Also, removal of the cylinder, even at the end of its useful life due to the presence of residual gas, will usually cause compressed gas to be released, which can be sudden and energetic and can be startling to the user.

U.S. Pat. No. 5,413,230 to Folter et al. describes a spring loaded plunger-type valve to enable refilling of a small gas cylinder. The device contains two seals and a crimp to secure the valve assembly. Although Folter et al.'s device is described as being hand-operated, the valve is not configured to allow opening and closing by the user. Folter et al.'s design also does not limit or allow for adjustment (e.g., variation) in the amount of gas flow to a mucosal surface (e.g., mucosal membrane) of the user. Furthermore, this arrangement is known to leak over time due to gas permeation through the seals.

Consequently, it would be beneficial to have a simple, low cost component for re-sealing an opening of a small compressed gas cylinder that also minimizes the force required for its opening. It would also be useful to have a device that is configured to allow the user to conveniently and easily close the cylinder prior to removal from the dispensing device in order to prevent the exhaust of compressed gas. It would be further advantageous if the design eliminated the timing issue involved in forming a seal between the gas cylinder and the dispensing component prior to opening the flow of gas.

### SUMMARY

Described here are devices that include small gas cylinders having integral valves. By “integral” it is meant that the valve is partially or wholly incorporated within, and comprises part of the structure of the gas cylinder. In general, the devices comprise an integral valve assembly comprising a valve seat and a valve pin. The valve seat will usually have an orifice with an orifice diameter. Adjustment of the diameter of the orifice will generally adjust the flow of gas through the valve to provide for variable flow. For example, decreasing the orifice diameter will limit gas flow through it. In some variations, the valve pin may be rotatably coupled to the valve seat.

The devices also include a gas cylinder having a neck with a distal end and an inner surface and comprising a compressed gas. An integral seal is also included for fixedly attaching at least a portion of the valve seat to the distal end or the inner surface of the gas cylinder neck. In some variations, the integral seal is a weld between the valve seat and the inner surface of the gas cylinder neck.

Exemplary compressed gases that may be included in the gas cylinders for dispensing to a mucosal membrane (e.g., the nasal or oral mucosa) of a user include carbon dioxide, nitric oxide, oxygen, gaseous acids, helium, their derivatives and combinations thereof.

Methods for dispensing a compressed gas are also described herein. In some variations, the method includes positioning a device proximate a mucosal membrane, where the device comprises a valve assembly comprising a valve seat and a valve pin, the valve seat including an orifice having an orifice diameter and the valve pin being rotatably coupled in the valve seat, a gas cylinder having a neck with a distal end and an inner surface and comprising the compressed gas, and an integral seal for fixedly attaching at least a portion of the valve seat to the distal end or the inner surface of the gas cylinder neck; and rotating the valve pin in a first direction to allow the compressed gas to flow through the orifice. The method may further include the step of rotating the valve pin in the reverse direction to the first direction, by an equivalent amount of rotation as turned in the first direction to seal the gas cylinder.

### BRIEF DESCRIPTION OF THE DRAWINGS

FIG. 1 illustrates an exemplary integral valve.

FIG. 2 depicts an integral valve according to another variation.

FIG. 3 illustrates the flow of gas using the valve shown in FIG. 2.

### DETAILED DESCRIPTION

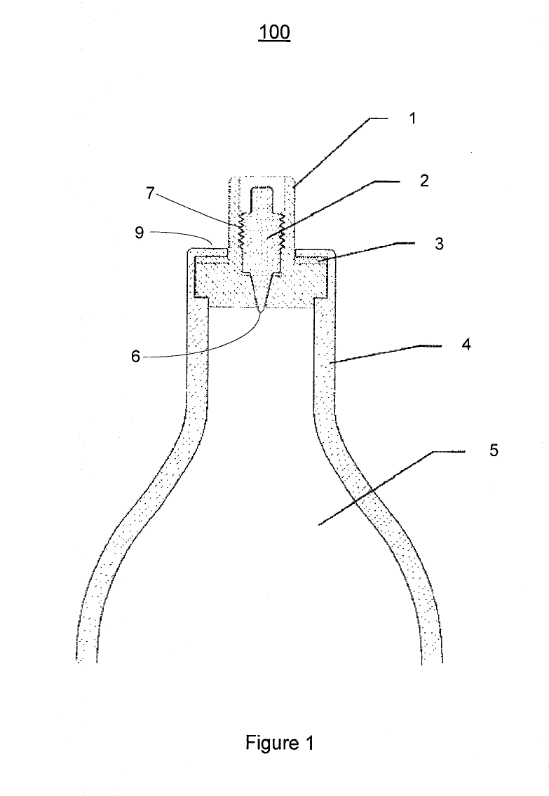

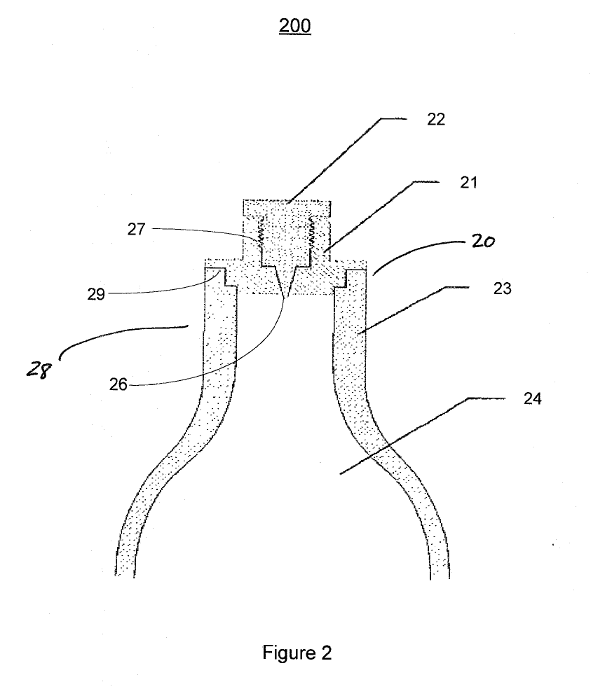

Described here are devices comprising gas cylinders having integral valves, as illustrated by the two variations, 100 and 200, shown in FIG. 1 and FIG. 2, respectively. As previously stated, by “integral” it is meant that the valve is partially or wholly incorporated within, and comprises part of the structure of the gas cylinder. The gas cylinders generally include a compressed gas, e.g., a therapeutic gas such as carbon dioxide, nitric oxide, oxygen, gaseous acids, helium, and combinations thereof. These variations are described in more detail below.

The devices described here are generally configured to allow the opening and closing of a valve that is integrated into the neck of a small compressed gas cylinder, and which, requires minimal force to activate. The valve may be designed so that the valve pin is small in diameter so that the amount of force exerted on it by the compressed gas is minimized. By way of example, many commercially available small gas cylinders have a neck diameter of ⅜″ (about 0.95 cm). Carbon dioxide cylinders, for example, have a nominal internal pressure of 850 psi (5.86 MPa). 850 psi (5.86 MPa) pressure exerted on a ⅜″ (about 0.95 cm) diameter surface yields a force of more than 93 pounds (42 kg). For safety purposes then, it is very important that, upon removal of the cylinder from the device, the gas vent before the retention means (such as a thread) is terminated; otherwise the gas cylinder may easily become a projectile since this force could not be restrained manually. Referring to FIG. 1 and variation 100, the threaded portion 7 of valve pin 2 has a diameter of approximately 1/10″ (about 0.25 cm). Assuming the internal pressure of carbon dioxide at 850 psi (5.86 MPa), the resulting force exerted on the pin is less than 7 pounds (3.17 kg). Consequently, there is less thread resistance (vis-à-vis 93 lbs. (42 kg) vs. 7 lbs. (3.17 kg)) and significantly less of a safety issue. Referring to FIG. 2 and variation 200, a similar design is illustrated with the threaded portion 27 of valve pin 22. The valve pin 2 or 22 may be of any suitable diameter ranging from about 0.02″ (about 0.50 cm) to about 0.15″ (about 0.38 cm) or more, with the resulting force exerted on these pins of from about 0.3 lbf (about 0.14 kilogram-force) to 15 lbf (about 6.8 kilogram-force). However, it should be understood that a smaller valve pin diameter may necessitate a smaller thread pitch such that the extent of rotation required to open or close the valve pin to the same degree is greater for a valve pin of small diameter compared to one having a larger diameter.

The devices are generally configured to include an integral valve assembly comprising a valve seat and a valve pin. The valve seat will usually have an orifice with an orifice diameter. Adjustment of the diameter of the orifice will generally adjust the flow of gas through the valve to provide for variable flow. For example, decreasing the orifice diameter will limit gas flow through it. In some variations, the valve pin may be rotatably coupled in the valve seat.

The devices will also be configured to include a gas cylinder having a neck with a distal end and an inner surface and comprising a compressed gas. An integral seal is may be included for fixedly attaching at least a portion of the valve seat to the distal end or the inner surface of the gas cylinder neck. In some variations, the integral seal is a weld between the valve seat and the inner surface of the gas cylinder neck.

The devices may be used to dispense any suitable gas from the gas cylinder. Exemplary gases include without limitation, carbon dioxide, nitric oxide, oxygen, gaseous acids, helium, their derivatives and combinations thereof. In one variation, the gas cylinder comprises carbon dioxide for dispense to a mucosal membrane of a user. Known manufacturing practices may be employed for capping the gas cylinders, thereby decreasing the expense for its production.

Referring to FIG. 1, the integral valve comprises a valve assembly and a seal 3. In FIG. 1, the valve assembly includes a valve seat 1 and a valve pin 2. Referring to FIG. 2, the integral valve also comprises a valve assembly. In FIG. 2, the valve assembly includes a valve seat 21 and a valve pin 22. At least a portion of the valve seat 21 is fixedly attached to the inside of neck 28 of the gas cylinder 23 at its distal end 20. The valve seat 1 or 21 may be fixedly attached (sealed) to the inside neck of the gas cylinder 4 or 23 by either crimping 9 or welding 29.

The valve seat 1 or 21 has an orifice 6 or 26 that adjusts (e.g., limits) the flow rate of the gas. When the valve pin 2 or 22 is sufficiently rotated in a first direction, the compressed gas 5 or 24 flows with a flow rate limited by the size of the orifice 6 or 26. Typically, a sufficient rotation is a quarter turn or a half turn of the valve pin. When the valve pin 2 or 22 is rotated in a reverse direction to the first direction by an equivalent amount of rotation as turned in the first direction, then the gas cylinder 4 or 23 with an integral valve is sealed.

When the valve pin 2 or 22 is rotated, compressed gas 5 or 24 flows. When the valve pin 2 or 22 is rotated in reverse direction, the gas cylinder 4 or 23 is sealed,

Referring to FIG. 1 in further detail, the valve comprises valve seat 1, which sits in the neck of a conventional small compressed gas cylinder 4 and is affixed to it by means of crimping over the uppermost portion of the gas cylinder 4 neck. The valve seat 1 contains a threaded hole which tapers to a small hole or orifice 6 as the valve seat 1 opens to the compressed gas 5. Threaded into this hole is the valve pin 2 which may be screwed-in sufficiently to cause a complete occlusion (i.e., sealing) of the gas at the outlet port in the valve seat 1 or unscrewed to allow gas flow. Each action is reversible and repeatable. The valve seat 1 is retained by crimping the gas cylinder 4 neck and a seal 3 or a gasket may be used to seal the compressed gas 5 in the gas cylinder 4 with the integral valve.

As illustrated in FIG. 1, the valve seat 1 further comprises a top cylindrical portion and a bottom cylindrical portion, wherein center of the valve seat 1 is hollow, wherein the hollow portion of the valve seat 1 comprises a threaded hole in the top cylindrical portion of the valve seat 1 which tapers to the orifice 6 in the bottom cylindrical portion of the valve seat 1. As shown, the orifice is approximately 0.020 of an inch (about 0.50 cm) in diameter and limits the gas flow rate. This gas flow rate is also the maximum flow rate since the orifice diameter is rate limiting. The orifice diameter may range from about 0.001″ (about 0.003 cm) to about 0.05″ (0.13 cm) or more, depending on the rate of gas flow desired.

The valve pin 2 further comprises a threaded portion and a pointed end on a bottom portion of the valve pin 2. A seal 3, having a washer shape is installed on the outer diameter of the top cylindrical portion of the valve seat 1, and the bottom of the valve seat 1 is positioned inside the top (distal end) of the gas cylinder 4.

The top (distal end) of the gas cylinder 4 is crimped to the bottom cylindrical portion of the valve seat 1, and the seal 3 is positioned between the between crimped portion of the gas cylinder 4 and the bottom cylindrical portion of the valve seat 1. The valve pin 2 is threaded into the threaded hole in the top cylindrical portion of the valve seat 1 and the gas cylinder 4 is sealed when the pointed end of the valve pin 2 is rotated into the orifice located in the bottom cylindrical portion of the valve seat.

Variation 200 has a similar structure as variation 100 except for the method of sealing the valve assembly to the gas cylinder 23. The valve assembly comprises valve pin 22 and valve seat 21. The valve assembly is sealed into the gas cylinder 23 by welding 29 the bottom of the valve seat 21 to the inside of neck 28 of the gas cylinder 23. If the valve seat is to be welded in place, seal 3 may be eliminated as illustrate in FIG. 1.

Valve seat 1 may be molded in a suitable thermoplastic with a low gas permeability and high modulus such as a liquid crystal polymer (LCP), polysulfone polyacrylamide, or combinations thereof. Valve seat 21 may be machined in steel or a suitable equivalent since the part is to be welded in place. The valve pin 2 or 22 may be molded in a variety of low to moderate modulus thermoplastics such as polyethylene, polytetrafluoroethylene (PTFE), polyoxymethylene (e.g., Delrin® acetal resin) or acrylonitrile butadiene styrene (ABS), or copolymers thereof, or they may be machined in a soft metal such as brass or aluminum. The point is that the valve seat 1 or 21 is a rigid and impermeable gas barrier while the valve pin 2 or 22 will generally need to conform to and seal against the small hole at the inlet side of the valve seat 1 or 21. Because the hole is very small and the valve pin 2 or 22 is a relatively thick part, gas permeability is not a great concern if choosing a thermoplastic material. It should be clear to one skilled in the art that using metal components for each part may provide optimal gas barrier properties, as well as a welded seal compared to a crimp seal that contains an elastomeric seal or gasket.

A method for operating an integral valve of the compressed gas cylinder comprises the steps of obtaining the gas cylinder 4 or 23 with integral valve, rotating the valve pin 2 or 22 in a first direction, allowing the compressed gas 5 or 24 to flow at a flow rate, rotating the valve pin 2 or 22 in the reverse direction to the first direction by an equivalent amount of rotation as turned in the first direction, to seal the gas cylinder 4 or 23, and repeating the aforementioned steps.

In some variations, the method comprises positioning a device, e.g., a hand-held device, proximate a mucosal membrane, where the hand-held device comprises a valve assembly comprising a valve seat and a valve pin, the valve seat including an orifice having an orifice diameter and the valve pin being rotatably coupled in the valve seat, a gas cylinder having a neck with a distal end and an inner surface and comprising the compressed gas, and an integral seal for fixedly attaching at least a portion of the valve seat to the distal end or the inner surface of the gas cylinder neck; and rotating the valve pin in a first direction to allow the compressed gas to flow through the orifice. The method may further include the step of rotating the valve pin in the reverse direction to the first direction, by an equivalent amount of rotation as turned in the first direction to seal the gas cylinder.

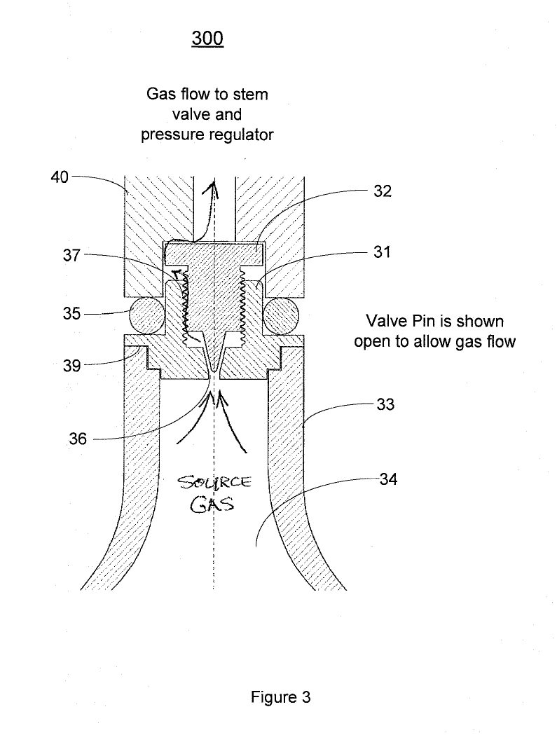

FIG. 3 illustrates the flow of gas in variation 200. As shown, the integral valve comprises valve seat 31 and valve pin 32. The gas cylinder 33 and valve seat 31 are welded 39 together. In the final assembly, the integral valve is intended to be activated by inserting the gas cylinder 33 with the integral valve into a dispensing mechanism that includes a seal such as an o-ring 35 that fits about the neck of the valve seat 31 and a rigid receiver 40 into which the valve pin 32 will be coupled. The user then twists or turns the gas cylinder 33 90 degrees or 180 degrees, for example, to lock the gas cylinder 33 into place in the dispenser mechanism and, at the same time, activates the gas flow by opening the valve pin 32. The compressed gas 34 flows from the gas cylinder 33 through the orifice 36, through the threaded portion 37 of the valve seat 31, into the internal cavity of the rigid receiver 40. To remove the gas cylinder 33 with integral valve, the user would reverse the sequence thereby closing the cylinder valve (i.e. rotating the valve pin 32) before removing the gas cylinder 33 with integral valve from the o-ring 35 and thus avoiding the seal timing issue referred to above.

The devices and integral valves described herein may be used for desktop, portable, non-portable, hand-held, or non-hand-held applications. For example, they may be beneficial to include in hand-operated, compressed gas dispensers such as carbon dioxide dispensing devices for beverage carbonation or medical therapeutic gas dispensers, or devices requiring, e.g., periodic replacement of a small gas cylinder as a calibrant gas.

1. A device comprising:
a valve assembly comprising a valve seat and a valve pin, the valve seat comprising an orifice having an orifice diameter and the valve pin being rotatably coupled to the valve seat;
a gas cylinder having a neck with a distal end an inner surface and comprising a compressed gas; and
an integral seal for fixedly attaching at least a portion of the valve seat to the distal end or the inner surface of the gas cylinder neck.

2. The device of claim 1, wherein the integral seal is a weld between the valve seat and the inner surface of the gas cylinder neck.

3. The device of claim 1, wherein the orifice diameter ranges from about 0.05 cm to about 0.38 cm.

4. The device of claim 1, wherein the orifice diameter is about 0.05 cm.

5. The device of claim 1, wherein the valve seat is made from a thermoplastic polymer or a metal.

6. The device of claim 5, wherein the thermoplastic polymer comprises a liquid crystal polymer, polysulfone or polyacrylamide.

7. The device of claim 1, wherein the valve pin is made from a thermoplastic polymer or a metal.

8. The device of claim 7, wherein the thermoplastic polymer comprises polyethylene, polytetrafluoroethylene, polyoxymethylene, acrylonitrile butadiene styrene, or copolymers thereof.

9. The device of claim 7, wherein the metal comprises brass or aluminum.

10. The device of claim 1, wherein the compressed gas is selected from the group consisting of carbon dioxide, nitric oxide, oxygen, gaseous acids, helium, their derivatives and combinations thereof.

11. The device of claim 1, wherein the compressed gas comprises carbon dioxide.

12. The device of claim 1, wherein the valve seat comprises a threaded portion.

13. The device of claim 1, wherein the valve pin comprises a threaded portion.

14. The device of claim 1, wherein the compressed gas flows out of the gas cylinder when the valve pin is rotated in a first direction.

15. The device of claim 14, wherein the gas cylinder is sealed when the valve pin is rotated in a reverse direction to the first direction, by an equivalent amount of rotation as turned in the first direction.

16. The device of claim 1, wherein adjustment of the orifice diameter adjusts the flow rate of the compressed gas.

17. A method for dispensing a compressed gas comprising:
positioning a device proximate a mucosal membrane, the device comprising:
a valve assembly comprising a valve seat and a valve pin, the valve seat comprising an orifice having an orifice diameter and the valve pin being rotatably coupled to the valve seat;
a gas cylinder having a neck with a distal end and an inner surface and comprising the compressed gas; and
an integral seal for fixedly attaching at least a portion of the valve seat to the distal end or the inner surface of the gas cylinder neck; and
rotating the valve pin in a first direction to allow the compressed gas to flow through the orifice.

18. The method of claim 17, further comprising rotating the valve pin in the reverse direction to the first direction, by an equivalent amount of rotation as turned in the first direction to seal the gas cylinder.

19. The method of claim 17, wherein the adjustment of the orifice diameter adjusts the flow rate of the compressed gas.

20. The method of claim 17, wherein the compressed gas is selected from the group consisting of carbon dioxide, nitric oxide, oxygen, gaseous acids, helium, and combinations thereof.

21. The method of claim 17, wherein the compressed gas comprises carbon dioxide.

22. The method of claim 17, wherein the force exerted on the valve pin by the compressed gas in the gas cylinder ranges from about 0.3 lbf to about 15 lbf.
